(19) United States
(12) Patent Application Publication
(10) Pub. No.: US 2023/0259762 A1
(43) Pub. Date: Aug. 17, 2023

(54) MACHINE LEARNING WITH INSTANCE-DEPENDENT LABEL NOISE

(71) Applicant: SAMSUNG ELECTRONICS CO., LTD., Suwon-si (KR)

(72) Inventors: Zhimeng JIANG, College Station, TX (US); Kaixiong ZHOU, Houston, TX (US); Zirui LIU, Houston, TX (US); Li LI, San Jose, CA (US); Rui CHEN, Sunnyvale, CA (US); Soo-Hyun CHOI, Santa Clara, CA (US); Xia HU, Bellaire, TX (US)

(73) Assignee: SAMSUNG ELECTRONICS CO., LTD., Suwon-shi (KR)

(21) Appl. No.: 17/972,302

(22) Filed: Oct. 24, 2022

Related U.S. Application Data
(60) Provisional application No. 63/310,040, filed on Feb. 14, 2022.

(51) Int. Cl. G06N 3/08

(52) U.S. Cl. CPC G06N 3/08

(57) ABSTRACT

An artificial intelligence (AI) classifier is trained using supervised training and an effect of noise in the training data is reduced. The training data includes observed noisy labels. A posterior transition matrix (PTM) is used to minimize, in a statistical sense, a cross entropy between a noisy label and a function of the classifier output. A loss function using the PTM is provided to use in training the classifier. The classifier provides final output predictions with good performance even with the existence of noisy labels. Also, information fusion is included in the classifier training using the PTM and an estimated noise transition matrix (NTM) to reduce estimation error at the classifier output.

### CROSS REFERENCE TO RELATED APPLICATION

This application claims benefit of priority of U.S. Provisional Application No. 63/310,040 filed Feb. 14, 2022, the contents of which are hereby incorporated by reference.

### FIELD

The present disclosure is related to reducing classification errors in a neural network when an input data set used for training includes mislabeled data.

### BACKGROUND

Neural networks are trained on labelled data. Datasets often contain erroneous labels, also called noisy labels. The neural network trained with noisy labels can be improved by formulating a noise transition matrix (NTM). NTM relies on an assumption that there are enough known data points in the datasets that are known to be correctly labeled or mislabeled to accurately model transition probabilities from clean labels to noisy labels. However, such an assumption does not hold true in many real world applications as label noise (noisy labels) in training datasets is instance-dependent and the underlying noise distribution does not follow a particular distribution (e.g., uniform distribution).

### SUMMARY

An artificial intelligence (AI) classifier is trained using supervised training and an effect of noise in the training data is reduced. The training data includes observed noisy labels. A posterior transition matrix (PTM) is used to minimize, in a statistical sense, a cross entropy between a noisy label and a function of the classifier output. A loss function using the PTM is provided to use in training the classifier. The classifier provides final output predictions with higher accuracy even with the existence of noisy labels. Also, information fusion is included in the classifier training using the PTM and an estimated noise transition matrix (NTM) to reduce estimation error at the classifier output.

Provided herein is a computer-implemented method of training a neural network, the computer-implemented method comprising: obtaining a data set, the data set comprising a plurality of instances (x₁, . . . , xₙ) and a plurality of labels (\tilde{y}₁, . . . , [symbol] ) each label of the plurality of labels corresponding to respective ones of the plurality of instances; training the neural network using the data set to obtain a first neural network; obtaining a first output (f) of the first neural network in response to a first instance (x) of the plurality of instances; obtaining a probability of a noisy label (\hat{P}) given x; obtaining a first transition matrix (PTM), wherein the obtaining the PTM comprises including in the PTM a term based on the first output and P; and updating the first neural network at a first time based on the PTM to obtain a second neural network.

Also provided herein is an apparatus for training a neural network, the apparatus comprising: one or more processors; and one or more memories, the one or more memories storing instructions configured to cause the apparatus to at least: obtain a data set, the data set comprising a plurality of instances (x₁, . . . , xₙ) and a plurality of labels (\tilde{y}₁, . . . , [symbol] ) each label of the plurality of labels corresponding to respective ones of the plurality of instances; train the neural network using the data set to obtain a first neural network; obtain a first output (f) of the first neural network in response to a first instance (x) of the plurality of instances; obtain a probability of a noisy label (\hat{P}) given x; obtain a first transition matrix (PTM), wherein the obtaining the PTM comprises including in the PTM a term based on the first output and P; and update the first neural network at a first time based on the PTM to obtain a second neural network.

Also provided herein is a non-transitory computer readable medium storing instructions for training a neural network, the instructions configured to cause a computer to at least: obtain a data set, the data set comprising a plurality of instances (x₁, . . . , xₙ) and a plurality of labels (\tilde{y}₁, . . . , [symbol] ) each label of the plurality of labels corresponding to respective ones of the plurality of instances; train a neural network using the data set to obtain a first neural network; obtain a first output (f) of the first neural network in response to a first instance (x) of the plurality of instances; obtain a probability of a noisy label (\hat{P}) given x; obtain a first transition matrix (PTM), wherein the obtaining the PTM comprises including in the PTM a term based on the first output and \hat{P}; and update the first neural network at a first time based on the PTM to obtain a second neural network.

Also provided herein is a server configured to train a neural network, the server comprising: one or more processors; a non-transitory computer readable medium storing instructions, the instructions configured to cause the one or more processors to at least: accessing a training sample comprising an input x and a noisy output label \tilde{y}; applying the input x to the neural network and receiving an observed output f(x); determining a posterior transition matrix (PTM) associated with the training sample based on the noisy output label y and the observed output f(x), wherein the PTM represents a posterior probability of having a clean output label y given the noisy output label y; determining a posterior loss based on the PTM; and updating the neural network based on the posterior loss.

In some embodiments of the server, the instructions are further configured to cause the one or more processors to at least perform: determining a noise transition matrix (NTM) associated with the training sample based on the observed output f(x) and anchor points, wherein the NTM represents a probability of the clean output label y flipping into the noisy output label y; determining a first reconstruction error associated with the NTM and a second reconstruction error associated with the PTM; determining a first weight and a second weight for a linear combination of the PTM and the NTM, wherein the first weight and the second weight are determined by a minimization of mean squared reconstruction error; and determining the posterior loss based on the linear combination of the PTM and the NTM.

### BRIEF DESCRIPTION OF THE DRAWINGS

The text and figures are provided solely as examples to aid the reader in understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of embodiments provided herein.

FIG. 1 illustrates training a classifier and performing inference and/or identifying noisy labels, according to some embodiments.

FIG. 2 illustrates example statistics associated with label noise and finding a posterior transition matrix (PTM), according to some embodiments.

FIG. 3 illustrates an overview logic flow for updating a neural network using a posterior forward loss found based on the PTM, according to some embodiments.

FIG. 4 illustrates a block diagram for updating the neural network based on estimating the PTM, according to some embodiments.

FIG. 5 illustrates a detailed flow for updating the neural network, according to some embodiments.

FIG. 6 illustrates exemplary hardware for implementation of computing devices such as the server 4-14, according to some embodiments.

### DETAILED DESCRIPTION

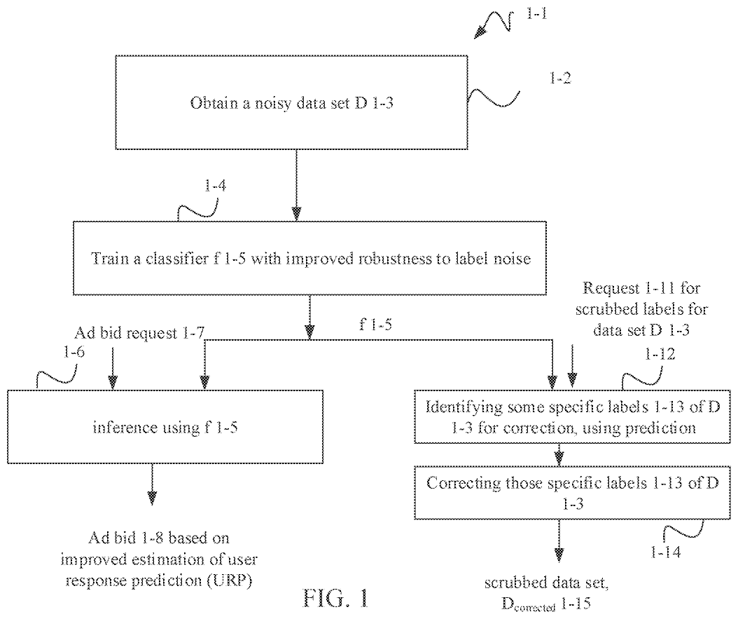

FIG. 1 illustrates a logic flow 1-1 for training a classifier 1-5.

Overall, noisy training samples (data D 1-3) are collected. In an example, the training samples may be bid requests, user feedback, user historical events (for example web search strings, user purchases, user clicks on particular web screens), and metadata of advertisements (“ads”).

The application of the embodiments are not limited as aforementioned and can be applied to other applicable environments.

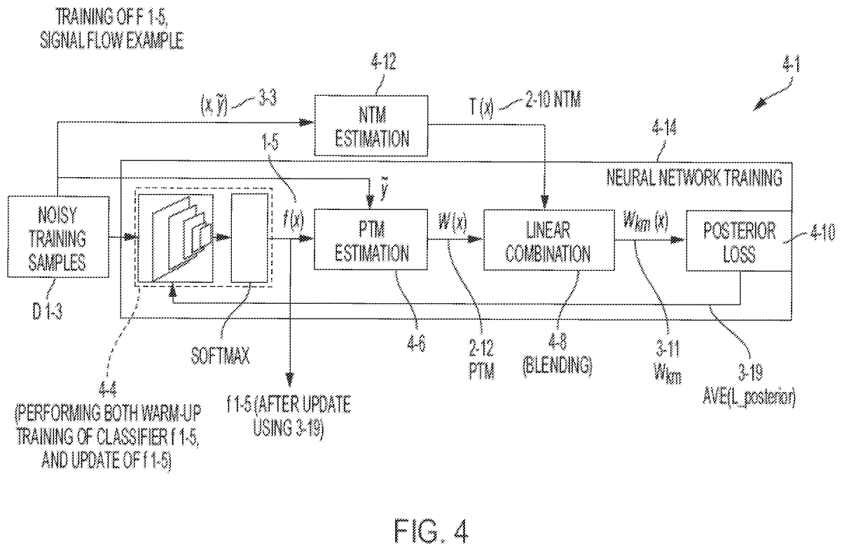

A noise transition matrix, NTM may be estimated offline based on the noisy training samples (D 1-3). A PTM may be estimated iteratively based on model prediction of the classifier 1-5 and observed noisy labels in D 1-3. The NTM and PTM may be combined based on an optimal Kalman gain. In addition to FIG. 1 described below, also see FIG. 4 item 4-8; a loss function with posterior loss may then be updated (see Lₚₒₛₜₑᵣᵢₒᵣ 3-17 and its average, 3-19) and the model f 1-5 be further trained (see FIG. 4 item 4-4). Finally, corrected labels may be obtained (see FIG. 1 operation 1-14) or inference may be performed with the trained model f 1-5 to predict how likely a user will respond to a potential ad (see FIG. 1 operation 1-8).

Specifically, FIG. 1 illustrates performing inference and/or identifying noisy labels. At operation 1-2, a noisy data set D 1-3 is received. At operation 1-4, the classifier 1-5 is trained with improved robustness to label noise.

At operation 1-6, an ad bid request 1-7 is received and inference is performed using classifier 1-5. An ad bid 1-8 is then output with improved estimation of user response prediction (URP).

Also shown in FIG. 1, the classifier 1-5 may be used to improve labels within the data set D 1-3. At operation 1-12, a request 1-11 for scrubbed labels for the data set D 1-3 is received. At operation 1-12, the logic flow 1-1 performs, using prediction, identifying some specific labels 1-11 for correction. At operation 1-14, the specific labels 1-11 are replaced with labels estimated to be more accurate. The estimation is performed using f 1-5. The classifier f 1-5 makes predictions on the data set D 1-3 and obtains a new dataset. By comparing the data set D 1-3 with the newly obtained data set, embodiments identify wrongly labeled instances.

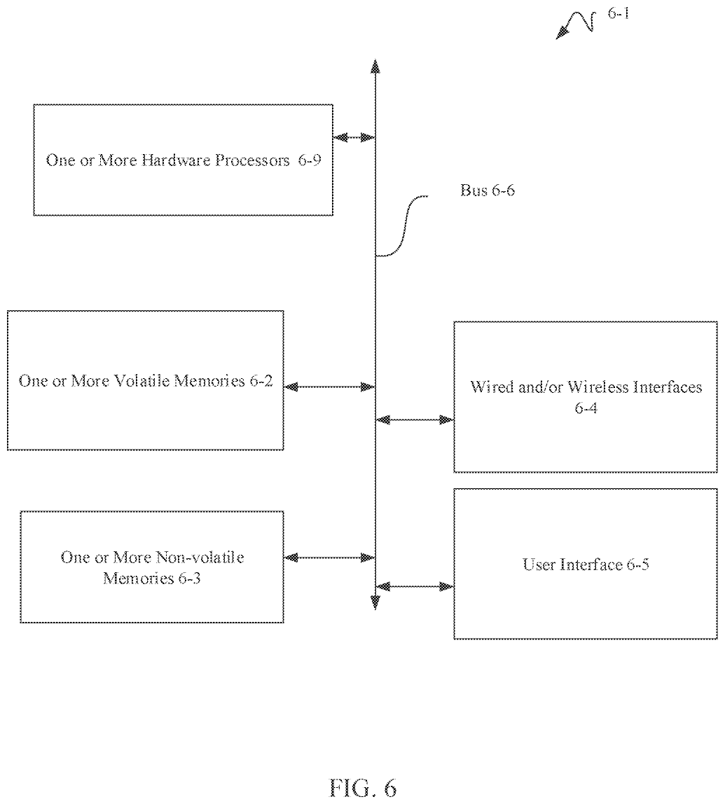

The logic flow of FIG. 1 may be performed by a server. For example, the server with exemplary structure as shown in FIG. 6.

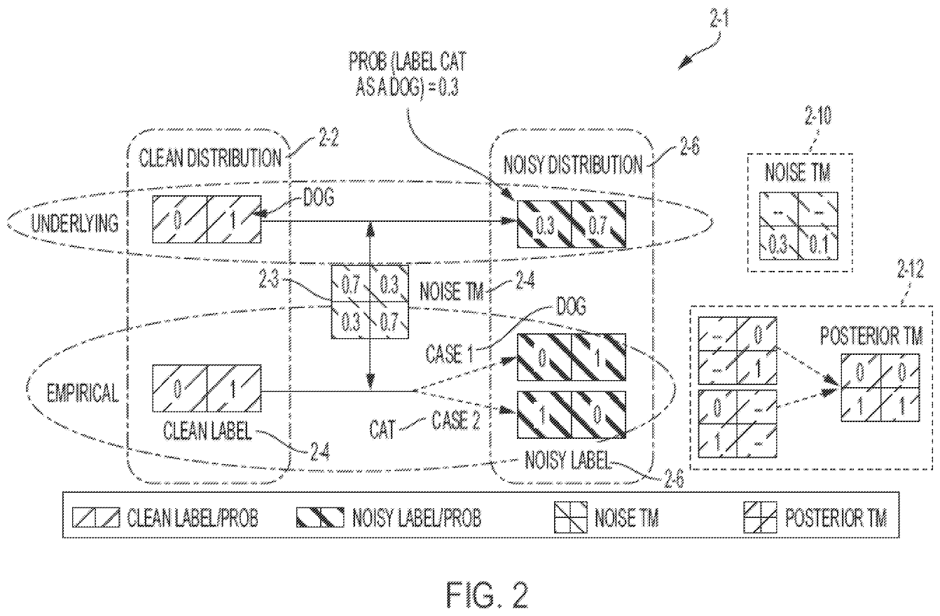

FIG. 2 illustrates an example classification problem in which images are presented and the classifier 1-5 classifies a given image x (also called a given instance) with a label, the label being either “dog” or “cat.”

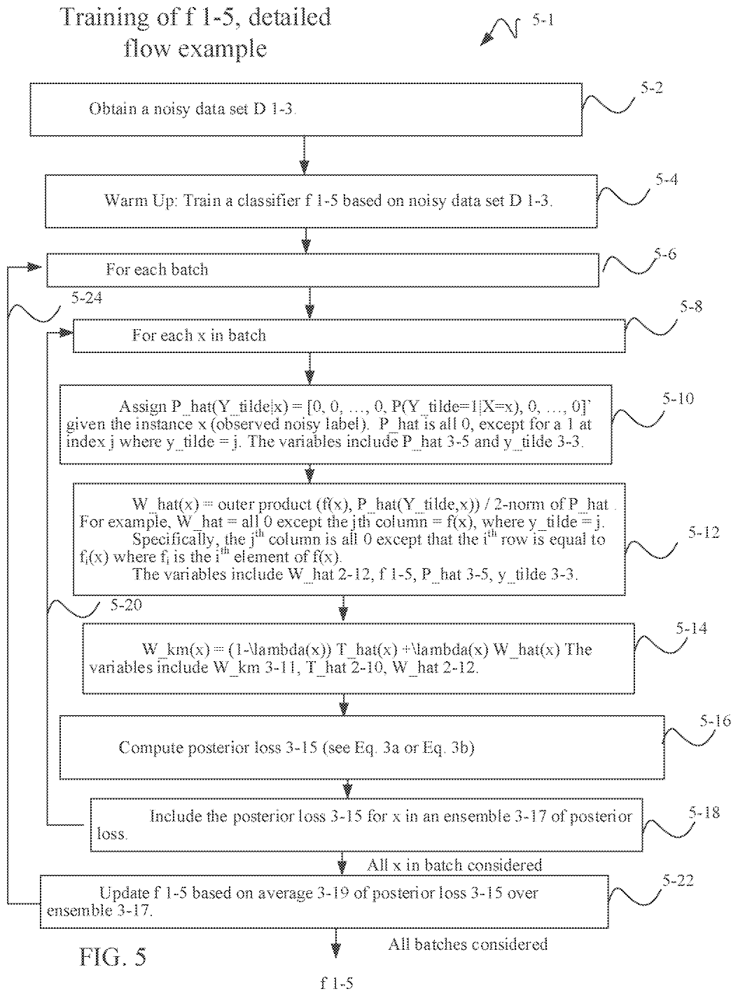

Embodiments presented herein compute a noise transition matrix (NTM) 2-10 (see FIG. 5 item 5-14), operate on the data using f-5 (see the branches “Case 1” and “Case 2” in the lower middle part of FIG. 2, and find a posterior transition matrix (PTM) 2-12. PTM 2-12 is then used to improve f 1-5 (not shown in FIG. 2, but see 4-8, 4-10 and 4-4 of FIG. 4).

In FIG. 2, an estimated NTM is assumed to have corrupted a clean label such as [0, 1] (clean label: x is an image of a dog). The noisy underlying distribution is [0.3, 0.7]. From observations (empirical), the label of this sample x is either the same as (Case 1) or different from (Case 2) the clean label, leading to different PTM 2-12 for this x. Thus, the observed noisy labels (posterior information on a basis of one image x, x is an instance, at a time) provide an inductive bias of label correction, and thus the estimated PTM 2-12 is useful for correcting the classifier 1-5.

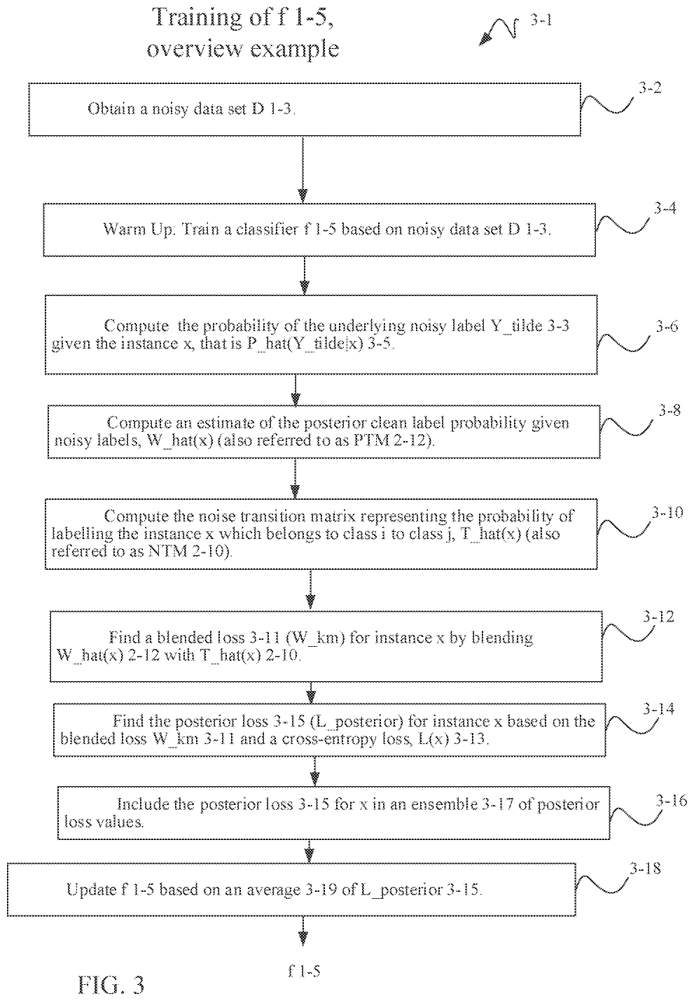

FIG. 3 provides an overview of training f 1-5 in the form of logic 3-1.

At operation 3-2, the noisy data set D 1-3 is obtained.

At operation 3-4, a warm up is performed in which f 1-5 is trained based on D 1-3. This training may use conventional supervised learning algorithms, since the training instances x in the set D 1-3 (for example, images) are provided with labels (although the labels are sometimes incorrect).

At operation 3-6, the probability \hat{P} 3-5 of the underlying noisy label \tilde{Y} 3-3 given the instance x is found. For an example, see “Case 1” and “Case 2” of FIG. 2.

At operation 3-8, logic 3-1 computes an estimate of the posterior clean probability given noisy labels, Ŵ, also referred to as PTM 2-12.

At operation 3-10, logic 3-1 computes a noise transition matrix \hat{T} also referred to as NTM 2-10. NTM 2-10 represents the probability of labeling instance x which belongs to class i to class j.

At operation 3-12, a blended loss 3-11 is found for instance x. The blended loss 3-11 blends PTM 2-12 with NTM 2-10.

The blended loss, in some embodiments, includes combining the PTM with a second transition matrix (NTM) to obtain a third transition matrix (WKM or W_km or Wₖₘ), wherein the updating comprises minimizing a loss function based on the WKM

At operation 3-14, a posterior loss, Lₚₒₛₜₑᵣᵢₒᵣ 3-15 for x is found based on the blended loss 3-11 and a cross entropy loss L(x) 3-13.

At operation 3-16, Lₚₒₛₜₑᵣᵢₒᵣ 3-15 is included in an ensemble 3-17 of posterior loss values. Operations 3-6 through 3-16 are repeated until the instances x in the noisy data set D 1-3 have been processed; the ensemble 3-17 is then considered to be complete and an average posterior loss 3-19 is found.

At operation 3-18, f 1-5 is updated based on the average posterior loss 3-19. The update may be performed using back propagation and stochastic gradient descent (SGD). Backpropagation is an algorithm used in artificial intelligence (AI) to fine-tune mathematical weight functions and improve the accuracy of an artificial neural network's outputs. In this case, f 1-5 and average posterior loss 3-19 are inputs to the back propagation and SGD algorithm, and an improved more robust f 1-5 is the output.

FIG. 4 illustrates a signal flow performed by a server 4-14 for training of f 1-5, according to some embodiments. The signal flow of FIG. 4 is described with respect to an example use case of addressing user response prediction (URP). However, the method described herein is not limited to URP. URP is a machine learning problem in demand-side platform (DSP) and may be a component of a digital advertising system. Due to the noisy labels introduced by accidental/fraud events and/or delayed feedback, URP models (AI classifiers processing a bid request to predict a response) may be misled to give wrong predictions and thus decrease classifier performance. FIG. 4 provides a signal flow to mitigate the impact of label noise, train robust URP models and provide predictions and labels with improved accuracy.

First, with the goal of utilizing the observed noisy labels, a posterior transition matrix (PTM), is used to describe the transition probabilities given the observed noisy labels. Second, a loss function incorporates the estimated PTM so that the final output predictions can be corrected even with the existence of noisy labels. Third, to further improve accuracy, an information fusion (IF) method may be used, which combines the estimated noise transition matrix (NTM) and PTM to achieve lower estimation error.

An architecture of an example embodiment is provided in FIG. 4. Overall, after receiving training samples (D 1-3) with noisy labels, the PTM 2-12 is estimated iteratively during training, and then the estimated PTM 2-12 is combined with the estimated NTM 2-10 via linear combination (by blending 4-8) to update the posterior loss function (corresponding to average 3-19) so that the trained model f 1-5 becomes robust to noise and is able to output probabilities and labels with improved accuracy.

Specifically, data D 1-3 is input to training 4-4, which trains the classifier f 1-5 and uses softmax to provide the classifier output f(x). At 4-16, PTM estimation is performed and PTM 2-12 is output. At 4-8, blending in the form of a linear combination is applied to PTM 2-12 (referring to the instance x) and to NTM 2-10 (also referring to the instance x). NTM 4-12 is obtained based on the instance x and the noisy label Y. The resulting matrix, Wₖₘ 3-11 is operated on to obtain a posterior loss 3-15 which is collected into the ensemble 3-17. The average 3-19 over the ensemble for all x is finally used to update f 1-5 at training 4-4. The ensemble 3-17 may be constructed at a batch level.

Based on FIG. 3, a neural network f 1-5 configured to classify an image such as the sample x by obtaining the data set D 1-3 as a first step. The data set D 1-3 includes a plurality of instances (x₁, . . . , xₙ) and a plurality of labels (\tilde{y}₁, . . . , [symbol] ) each label of the plurality of labels corresponding to respective ones of the plurality of instances. In a next step, the neural network f 1-5 is trained using the data set D 1-3 to obtain a first version of the neural network f 1-5. Then, in a next step a first output (f(x)) of the first neural network in response to a first instance (x) of the plurality of instances is found. In a next step, a probability of a noisy label (P) given x is obtained. Then a first transition matrix (PTM) is obtained, wherein the obtaining the PTM comprises including in the PTM a term based on the first output and P. Finally, the first neural network is updated at a first time based on the PTM to obtain a second neural network. In one non-limiting example, neural network f 1-5 may predict a response to images such as the sample x.

In another embodiment of FIG. 4, NTM estimation 4-12 and blending 4-8 are removed. In FIG. 3, operations 3-10 and 3-12 are not performed. An instance-dependent label noise ratio, IDN, may be defined as the rate at which a wrong label occurs in the data D 1-3. This reduced-complexity embodiment is suitable for a scenario when the instance-dependent label noise ratio is below about 20%.

FIG. 5 illustrates logic flow 5-1 which is a detailed flow example of training f 1-5.

At operation 5-2, the noisy data set D 1-3 is obtained.

At operation 5-4, warm up training is performed of f 1-5 using D 1-3.

Operation 5-6 indicates beginning of batch processing.

Operation 5-8 indicates beginning of processing of the instance x of the batch.

At operation 5-10, \hat{P} 3-5 is found based on \tilde{Y} 3-3 such that \hat{P} 3-5 is all 0 except for the j^{th} entry which is 1, for on \tilde{Y}(x)=j. That is, the classifier f 1-5 operating on x produces the index j (for example 1 or 2), which corresponds to the label \tilde{Y} 3-3 (for example, “dog” or “cat” see FIG. 2).

At operation 5-12, the PTM 2-12 is found as the outer product of f(x) with \hat{P} 3-5. For a vector u and a vector v and the outer product A=u^{T}v, the element A_{i,j}=uᵢ*vⱼ, where “*” is scalar multiplication and “u^{T}” is vector transpose of u.

At operation 5-14, blending 4-8 is performed between NTM 2-10 and PTM 2-12. NTM 2-10 may be found using a conventional technique.

At operation 5-16, the posterior loss Lₚₒₛₜₑᵣᵢₒᵣ 3-15 is found.

At operation 5-18, the posterior loss Lₚₒₛₜₑᵣᵢₒᵣ 3-15 is included in an ensemble 3-17. When all x in the batch have been considered, the average 3-19 of the ensemble 3-17 is found. Otherwise path 5-20 is taken back to 5-8 to obtain another x from D 1-3.

At operation 5-22, f 1-5 is updated based on the average 3-19. If all batches have been considered, then f 1-5 is output as the improved classifier. Otherwise, path 5-24 is taken back to 5-6 to begin a new batch.

Exemplary performance of the trained classifier 1-5 is provided in U.S. Provisional Application No. 63/310,040 filed Feb. 14, 2022 at FIG. 3 and Tables 1 and 2. For example, on the SVHN data set with a high level of label noise, embodiments provide a classification accuracy of 85% to 91.66% while state of the art methods provide classification accuracy of 80% to 90.7% under the same conditions. See the columns labelled IDN-40% and IDN-50% in Table 1 of U.S. Provisional Application No. 63/310,040.

For example details of the operations of FIGS. 3-5, the following derivations and discussions are provided.

Let function f 1-5 represent a neural network and f(x) denote the c dimensional output probability for instance x, where the i^{th} index of the output fᵢ(x) represents the predicted probability for class i. An approach is to minimize the cross-entropy (CE) loss L(f(x), y)=−log(f_{y}(x)) to force the output f_{y}(x) to approximate 1. However, the label noise may mislead a deep learning model. In some embodiments, an approach is to first estimate NTM T(x) 2-10 and then adopt it to correct the loss function, L 3-15. For example, in a forward correction procedure, the estimated NTM 2-10 is adopted to corrupt the predicted probability f(x) 1-5, i.e., the corrupted predicted probability varies as f(x)=T(x)^{T}f(x), and then the corrupted predicted probability is enforced to approximate the noisy label Y 3-3. Suppose T(x) 2-10 is non-singular and the loss function L 3-15 is proper and composite. The forward loss correction can achieve a consistent classifier, i.e., the optimal classifier for the corrected loss with respect to the underlying noisy distribution is the same as that for the CE loss with respect to the underlying clean distribution.

$$f = arg {min}_{f} {E}_{X , \tilde{Y} ∼ P ( X , \tilde{Y} )} L ( \tilde{Y} , {T ( X )}^{T} f ( X ) ) \qquad Eq . 1$$

The main goal is to train a c-class neural network classifier f 1-5 to predict the clean label probability P(Y|X). Since only the noisy labels are observed, there is a gap between the clean and noisy label, described via NTM 2-10.

Motivated by the observed noisy labels (i.e., posterior information), embodiments define the PTM W(x) 2-12 to describe the posterior clean label probability given noisy labels, where W_{i,j}(x)=P(Y=i|\tilde{Y}=j, X=x). The relationship between the PTM W(x) 2-12 and NTM T(x) 2-10 can be expressed via Bayes' rule as shown in Eq. 2.

$${W}_{i , j} ( x ) = \frac{P ( Y = i \vert X = x ) {T}_{i , j} ( x )}{{\sum }_{i = 1}^{c} P ( Y = i \vert X = x ) {T}_{i , j} ( x )} \qquad Eq . 2$$

The summation of any column is 1 for PTM W(x), while the summation of any row is 1 for NTM T(x). Embodiments provide a posterior loss correction method via NTM.

The model prediction is f(x) for noisy sample (x, \tilde{y}) and W(x) is the PTM 2-12 associated with the noisy sample x.

In some embodiments, a posterior forward loss is used for training (Eq. 3a).

L_{forward}=L(\tilde{y}Σᵢ₌₁^{c}W_{i,\tilde{y}}(x)fᵢ(x)) Eq. 3a

where fᵢ(x) is the i^{th} element of f(x).

In some embodiments, a posterior reweight loss 3-15 is used (Eq. 3b).

The posterior reweight loss 3-15 is defined as in Eq. 3b.

L_{reweight}=Σᵢ₌₁^{c}W_{i,\tilde{y}}(x)L(i,f(x)) Eq. 3b

In FIGS. 3, 4 and 5, Lₚₒₛₜₑᵣᵢₒᵣ may be achieved using either L_{forward} or L_{reweight}.

An analysis of expected risk and empirical risk shows that the posterior reweight loss can achieve a consistent classifier for the underlying distribution and the empirical distribution. “Underlying distribution” means the true distribution and “empirical distribution” is the distribution relying on noisy labels.

The optimal solution for finding PTM 2-12 is using the minimal Frobenius norm. The solution is expressed in Eq. 4. Ŵ may also be referred to as W_hat herein, \tilde{Y} may be referred to as Y_tilde herein.

$$\hat{W} ( x ) = \frac{f ( x ) {\hat{P} ( \tilde{Y} \vert x )}^{T}}{Two Norm Squared of \hat{P} ( \tilde{Y} \vert x )} \qquad Eq . 4$$

Eq. 4 provides the PTM estimation for general empirical noisy label distributions. For the case of instance x with only a single occurrence, the empirical noisy distribution satisfies Two Norm of \hat{P}(\tilde{Y}|x)=1. And this empirical noisy distribution achieves consistent estimated PTM 2-12 in Equation (4).

Eq. 4 provides PTM estimation method based on the observed noisy labels D 1-3. However, the condition that a neural network approximates clean labels could still be strong even after the warm-up strategy and iterative estimation are adopted, and PTM estimation error could be large for large noisy label rates. To further reduce the estimation error, motivated by Kalman filtering, embodiments provide an information fusion (IF) approach to obtain more accurate transition matrix estimation via weighted average of PTM 2-12 and NTM 2-10.

Intuitively, for each instance, the estimated NTM 2-10 and PTM 2-12 may have different estimation accuracy, and, therefore, it is possible to obtain a more accurate transition matrix estimation by adaptively and linearly combining these two matrices. Embodiments quantify the estimation uncertainty and assign higher weight for the estimation with lower uncertainty. In this way, a more accurate estimated transition matrix is generated.

Uncertainty is obtained by modeling as follows. For the estimated NTM 2-10, the the noisy label \tilde{Y} satisfies c-dimension Bernoulli distribution with parameter \tilde{f}.

Once the uncertainty has been established, embodiments integrate the two estimated transition matrices into a Kalman transition matrix, defined as Wkm(x), via a weighted average operation. Mathematically, the Kalman transition matrix is given by Eq. 5. Wₖₘ may be referred to as W_km or WKM herein. \hat{T} may referred to as T_hat herein.

Wₖₘ(x)=(1−λ(x))\hat{T}(x)+λ(x)Ŵ(x) Eq. 5

Hardware for performing embodiments provided herein is now described with respect to FIG. 6. FIG. 6 illustrates an exemplary apparatus 6-1 for implementation of the embodiments disclosed herein. For example, each of parameter server 2-8, and base station 2-12 may be implemented using the apparatus 6-1. Similarly the training server mentioned with respect to FIG. 7 may be implemented using an instance of the apparatus 6-1. The apparatus 6-1 may be a server, a computer, a laptop computer, a handheld device, or a tablet computer device, for example. Apparatus 6-1 may include one or more hardware processors 6-9. The one or more hardware processors 6-9 may include an ASIC (application specific integrated circuit), CPU (for example CISC or RISC device), and/or custom hardware. Apparatus 6-1 also may include a user interface 6-5 (for example a display screen and/or keyboard and/or pointing device such as a mouse). Apparatus 6-1 may include one or more volatile memories 6-2 and one or more non-volatile memories 6-3. The one or more non-volatile memories 6-3 may include a non-transitory computer readable medium storing instructions for execution by the one or more hardware processors 6-9 to cause apparatus 6-1 to perform any of the methods of embodiments disclosed herein.

Through the above embodiments, higher quality labels can be generated so that improved classification can be performed. In an exemplary application, the use of the above embodiments can result in more accurate classification by the use of a neural network trained with blended loss 3-11. An example of the neural network is the classifier 1-5. In some embodiments, the blended loss 3-11 is based on the posterior clean label probability given noisy labels (PTM 2-12). For example, the improved neural network results in more accurate output classifications with higher accuracy.

Overall, explicitly considering label noise improves the accuracy of supervised learning models (for example, classifier f 1-5). In practice, it is not possible to have 100% clean data in practice. The above embodiments model label noise during training and reduce misleading of supervised learning models (see FIGS. 1 and 4). Applications of improved training are applicable in, for example, demand-side platforms.

For example, performance of the classifier f 1-5 on example benchmark datasets, CIFAR-10 and SVHN, is improved over alternative approaches. Classifier f 1-5 achieves better performance than alternative approaches across different datasets and over a range of noise rates. For example, the higher accuracy indicates that the posterior information is particularly important for higher noise rates. Thus, by explicitly rectifying noisy labels, embodiments provide robust models and corrected predictions, and therefore improve the performance.

What is claimed is:

1. A computer-implemented method of training a neural network, the computer-implemented method comprising:
obtaining a data set, the data set comprising a plurality of instances (x₁, . . . , xₙ) and a plurality of labels (\tilde{y}₁, . . . , [symbol] ), each label of the plurality of labels corresponding to respective ones of the plurality of instances;
training the neural network using the data set to obtain a first neural network;
obtaining a first output of the first neural network in response to a first instance x₁ of the plurality of instances;
obtaining a probability of a noisy label (\hat{P}) given x₁;
obtaining a first transition matrix (PTM), wherein the obtaining the PTM comprises including in the PTM a term based on the first output and \hat{P}; and
updating the first neural network at a first time based on the PTM to obtain a second neural network.

2. The computer-implemented method of claim 1, wherein the second neural network is more robust to a label noise than the first neural network.

3. The computer-implemented method of claim 1, further comprising:
estimating a corrected label ŷ₁ of the first instance x₁ using the second neural network;
forming a second data set from the data set by replacing \tilde{y}₁ with [symbol] ;
repeating the estimating and forming for remaining instances of the data set, wherein a plurality of corrected labels comprises ŷ₁, . . . , ŷₙ; and
outputting the plurality of corrected labels as a scrubbed data set.

4. The computer-implemented method of claim 3,
wherein the obtaining the data set comprises receiving the data set from a user, and wherein the outputting the scrubbed data set comprises outputting the scrubbed data set to the user.

5. The computer-implemented method of claim 1, wherein the data set includes first information indicating accidental ad clicks, second information indicating fraud clicks, and third information including delayed feedback.

6. The computer-implemented method of claim 1, wherein the obtaining the data set comprises receiving the data set from an ad exchange server.

7. The computer-implemented method of claim 6, further comprising:
receiving, from the ad exchange server, a bid request; and
computing user response prediction (URP) by inputting the bid request to the second neural network.

8. The computer-implemented method of claim 1, wherein the obtaining the first transition matrix (PTM) comprises minimizing a norm of the PTM after a warm-up training.

9. The computer-implemented method of claim 8, wherein the norm is a Frobenius norm, and a solution to find the PTM with the Frobenius norm is based on noisy labels comprised in the data set and based on the PTM.

10. The computer-implemented method of claim 8, wherein the norm is a Frobenius norm, and the minimizing the norm of the PTM comprises:
initializing all entries of the PTM to 0;
computing f for an index i=1;
obtaining a classification j=argmax(f(x₁));
setting column j of the PTM equal to the corresponding entries of the output; and
repeating the obtaining and the setting for the index i=2, . . . , n.

11. The computer-implemented method of claim 1, further comprising combining the PTM with a second transition matrix (NTM) to obtain a third transition matrix (WKM),
wherein the updating comprises minimizing a loss function based on the WKM.

12. The computer-implemented method of claim 11, wherein:
the combining the PTM with the second transition matrix (NTM) to obtain a third transition matrix (WKM) is performed for the index i;
the updating the neural network the first time based on the WKM is performed for the index i.

13. An apparatus for training a neural network neural network, the apparatus comprising:
one or more processors; and
one or more memories, the one or more memories storing instructions configured to cause the apparatus to at least:
obtain a data set, the data set comprising a plurality of instances (x₁, . . . , xₙ) and a plurality of labels (\tilde{y}₁, . . . , [symbol] ), each label of the plurality of labels corresponding to respective ones of the plurality of instances;
train the neural network using the data set to obtain a first neural network;
obtain a first output of the first neural network in response to a first instance (x₁) of the plurality of instances;
obtain a probability of a noisy label (\hat{P}) given x₁;
obtain a first transition matrix (PTM), wherein the obtaining the PTM comprises including in the PTM a term based on the first output and \hat{P}; and
update the first neural network at a first time based on the PTM to obtain a second neural network.

14. The apparatus of claim 13, wherein the instructions are further configured to cause the apparatus to:
estimate a corrected label ŷ₁ of the first instance x₁ using the second neural network;
form a second data set from the data set by replacing \tilde{y}₁ with [symbol] ;
repeat by repeating estimating and forming for remaining instances of the data set, wherein a plurality of corrected labels comprises ŷ₁, . . . , ŷₙ; and
output the plurality of corrected labels as a scrubbed data set.

15. The apparatus of claim 14,
wherein the instructions are further configured to cause the apparatus to obtain the data set by receiving the data set from a user, and output the scrubbed data set by outputting the scrubbed data set to the user.

16. The apparatus of claim 13, wherein the instructions are further configured to cause the apparatus to obtain the data set by receiving the data set from an ad exchange server.

17. The apparatus of claim 16, wherein the instructions are further configured to cause the apparatus to:
receive, from the ad exchange server, a bid request; and
computing user response prediction (URP) by inputting the bid request to the second neural network.

18. The apparatus of claim 13, wherein the instructions are further configured to cause the apparatus to obtain the first transition matrix (PTM) by minimizing a norm of the PTM after a warm-up training.

19. The apparatus of claim 13, wherein the instructions are further configured to cause the apparatus to combine the PTM with a second transition matrix (NTM) to obtain a third transition matrix (WKM),
wherein the instructions are further configured to cause the one or more processors to update by minimizing a loss function based on the WKM.

20. A non-transitory computer readable medium storing instructions for training a neural network, the instructions configured to cause a computer to at least:
obtain a data set, the data set comprising a plurality of instances (x₁, . . . , xₙ) and a plurality of labels (\tilde{y}₁, . . . , [symbol] ), each label of the plurality of labels corresponding to respective ones of the plurality of instances;
train a neural network using the data set to obtain a first neural network;
obtain a first output of the first neural network in response to a first instance x₁ of the plurality of instances;
obtain a probability of a noisy label (\hat{P}) given x₁;
obtain a first transition matrix (PTM), wherein the obtaining the PTM comprises including in the PTM a term based on the first output and \hat{P}; and
update the first neural network at a first time based on the PTM to obtain a second neural network.
